(19) United States
(12) Patent Application Publication
(10) Pub. No.: US 2021/0020043 A1
(43) Pub. Date: Jan. 21, 2021

(54) METHOD FOR NAVIGATING AND LOCATING BY SATELLITE, NAVIGATION DEVICE, AND COMPUTER DEVICE

(71) Applicant: TRIPLE WIN TECHNOLOGY(SHENZHEN) CO.LTD., Shenzhen (CN)

(72) Inventor: KUO-HUNG LIN, New Taipei (TW)

(21) Appl. No.: 16/693,691

(22) Filed: Nov. 25, 2019

(30) Foreign Application Priority Data
Jul. 17, 2019 (CN) 201910649008.3

(51) Int. Cl. G08G 1/0969; G08G 1/0968; G09B 29/10; G01C 21/32

(52) U.S. Cl. CPC G08G 1/0969; G08G 1/096844; G09B 29/106; G08G 1/096827; G08G 1/096838; G08G 1/096811; G01C 21/32

(57) ABSTRACT

A navigation method comprising: scanning two-dimensional codes using a code scanning unit of a user terminal and obtaining two-dimensional code; comparing the information of the acquired two-dimensional code with the information in a database, and marking the position corresponding to each two-dimensional code in a map, wherein the database stores the map of the preset area and a relation of all positions of the map and the two-dimensional code information; receiving a target position input by a user, and finding a path information between the current position corresponding to the two-dimensional code and the target position; and outputting the current position and the path information.

### FIELD

The subject matter herein generally relates to navigation, especially to navigation method, navigation device, and computer device.

### BACKGROUND

Global satellite navigation system is widely used. Complex environmental factors, such as being inside buildings, being underground, and other areas, make accurate positioning difficult. When mobile navigation software is attempting to self-locate, due to the margins of positioning error of about 10 meters, the navigation effect may not be good and the positioning may not be accurate.

Therefore, there is room for improvement within the art.

### BRIEF DESCRIPTION OF THE DRAWINGS

Implementations of the present technology will now be described, by way of embodiments only, with reference to the attached figures.

FIG. 1 is a schematic diagram of an application environment architecture of a navigation method in accordance with one embodiment.

FIG. 2 is a flow chart of a navigation method in accordance with one embodiment.

FIG. 3 is a schematic diagram of a navigation device in accordance with one embodiment.

FIG. 4 is a schematic diagram of a computer device in accordance with one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

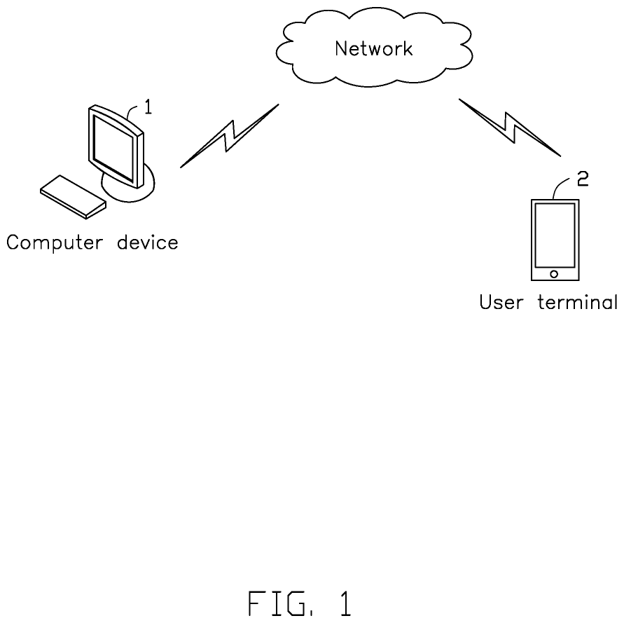

FIG. 1 is a schematic diagram of the application environment architecture of the navigation method in accordance with one embodiment.

The navigation method is applied to a computer device 1. The computer device 1 and a user terminal 2 establish a communication connection through a network. In one embodiment, the user terminal 2 can be a smart phone having a code scanning unit, a tablet computer with a code scanning unit, and the like. The computer device 1 locates a current position according to a two-dimensional code collected by the code scanning unit of a user terminal 2 and sends positioning information of current position to the user terminal 2. The network can be wired or wireless, e.g. radio, WI-FI, cellular, satellite, broadcast, etc.

The computer device 1 may be an electronic device having navigation software, such as a personal computer, a server, etc., wherein the server may be a single server, a server cluster, a cloud server, etc.

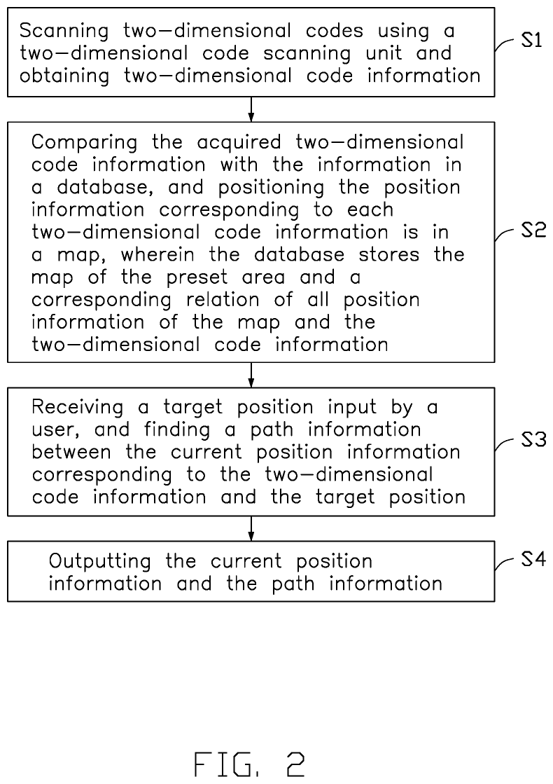

Referring to FIG. 2, a flowchart of a navigation method is provided in accordance with one embodiment. The order of steps in the flowchart may be changed according to different needs and some steps may be omitted.

Step S1, a two-dimensional code is scanned by a code scanning unit of a user terminal 2, and the two-dimensional code information is obtained.

In one embodiment, the two-dimensional code at least can be selected from one of a two-dimensional code of a doorplate and a two-dimensional code carried by a store or store chain.

The method for acquiring the two-dimensional code information can be selected from one of the two following ways:

A first way: a doorplate code is scanned by a code scanning unit of a user terminal 2, and positional information in the two-dimensional code is extracted. Wherein the positional information comprises at least one of a residential quarter name and a doorplate number.

A second way: a two-dimensional code carried by a store or store chain is scanned by a code scanning unit of a user terminal 2, and positional information in the store code is extracted, the store information comprises at least one of a store name and a store address.

For example, a doorplate code is scanned by a code scanning unit of a user terminal 2, and the doorplate two-dimensional code information is sent to the computer device 1. The computer device 1 obtains a current positional information in the two-dimensional code information of the doorplate is building five, room 101, of the road 128. In another embodiment, a store code is scanned by a two-dimensional scanned unit of a tablet computer. The two-dimensional code carried by a store or store chain includes a name of the store and an address of the store. The store name and address are sent to the computer device 1 via network. For example, the current positional information determined by the store code information is about a certain supermarket on a certain road.

Step S2, the acquired two-dimensional code information is compared with the information in a database, and the current positional information of the two-dimensional code information is marked in a map. Wherein a map of a preset area and a corresponding relation of all the positional information in the map and the two-dimensional code information of all buildings of the preset area are stored in the database.

In one embodiment, a method for building the database may include:

Firstly, all of two-dimensional code information of the preset area are acquired.

Secondly, positional information determined by each two-dimensional code information is extracted.

Thirdly, each piece of positional information is marked on a map of the preset area, and the map of the preset area comprises the positional information of all the buildings in the preset area.

The preset area can be an interior of a public place such as a large shopping mall, an exhibition hall, and the like, and can also be a city, a country, and the like.

For example, the computer device 1 acquires all two-dimensional code information in a preset area transmitted by the code scanning unit of a user terminal 2. Wherein the positional information in each two-dimensional code information may comprises a road name, a building name, a doorplate number, shop name, a community name, and the like. The computer device 1 is used for marking all the positional information on the map of a preset area, and the map of the preset area comprises positional information of all buildings in the preset area.

The steps of comparing the obtained two-dimensional code information with the information in the database, and locating the positional information of the two-dimensional code information include:

Firstly, positional information of each two-dimensional code information is obtained.

Secondly, each piece of positional information is looked up in the database and each piece of positional information is located on the map of the preset area.

For example, the computer device 1 acquires the two-dimensional code information transmitted by the code scanning unit of a user terminal 2; extracts the positional information in the two-dimensional code information, and compares the positional information with the positional information in the database, then finds out the positional information in the database corresponding to the positional information, and finds the coordinate position on the map of the preset area corresponding to the positional information in the database. Lastly, stores the coordinate position and positional information of the two-dimensional code information corresponding to the coordinate position. For example, the computer device 1 receives a two-dimensional code sent by the code scanning unit of a user terminal 2 and extracts a current positional information of the two-dimensional code is room 101, Building 5 at 128 Construction Road, and the computer device 1 compares the positional information with the positional information in the database, and finds out that the coordinate information corresponding to the positional information is: longitude, 96° 10.9′ and latitude 38° 12′, and the coordinate position and the positional information of the two-dimensional code corresponding to the coordinate position is stored in the computer device 1, and the coordinate position is marked on the map. The method of marking can use special symbols, such as triangles, circles, etc., to mark on the map.

Step S3, the computer device 1 receives a target position input by a user, and finds path information between a current positional information corresponding to the two-dimensional code information and the target position.

The method of finding the path information between the current positional information and the target position may include:

Firstly, the target positional information is obtained and coordinates corresponding to the target positional information on a map are discovered.

Secondly, all paths from the current positional information of the two-dimensional code information to the target position are determined using a shortest path algorithm.

The method of determining a shortest path from the current position of the two-dimensional code information to the target position by using the shortest path algorithm includes:

Firstly, marking position coordinates of all intersections between the position determined by the two-dimensional code information and the target position on the map.

Secondly, determining a passing direction of vehicles between each two adjacent intersections. The vehicles can be bus, car, on foot or bicycle.

Thirdly, calculating a passing distance and/or passing time between each two adjacent intersections.

Lastly, the shortest path algorithm is used to calculate a shortest path and the minimum use time between the current position determined by the two-dimensional code information and the target position.

For example, the computer device 1 acquires the target positional information, looks up a position coordinate corresponding to the target positional information in the map, for example, the target position is a library, the position coordinate of the library is longitude: 96° 11′, latitude: 38° 12′, and the current positional information acquired by the code scanning unit of a user terminal 2 is: longitude, 96° 10.9′ and latitude 38° 12′. Position coordinates of all intersections between the target position and the position of the two-dimensional code information are found, and determine a passing direction of vehicles between each two adjacent intersections, such as one-way or two-way. The travelling distance and/or time between two adjacent intersections is calculated, and the shortest path between the position of the two-dimensional code information and the target position is calculated by using the shortest path algorithm. The shortest path algorithm can include Dijkstra algorithm, A-star algorithm, highway hierarchies algorithm and so on.

Step S4: the current positional information and path information is output to the user terminal 2.

In one embodiment, the computer device 1 sends the positional information corresponding to the two-dimensional code information and the positioning information of the positional information on the map to the user terminal 2 through SMS, mail, telephone, and instant communication software.

In another embodiment, the computer device 1 sends the positional information corresponding to the two-dimensional code information and the path information of the positional information to the destination position to the user terminal 2 by means of SMS, mail, telephone, and instant communication software. The navigation method is introduced in detail in FIG. 2 above.

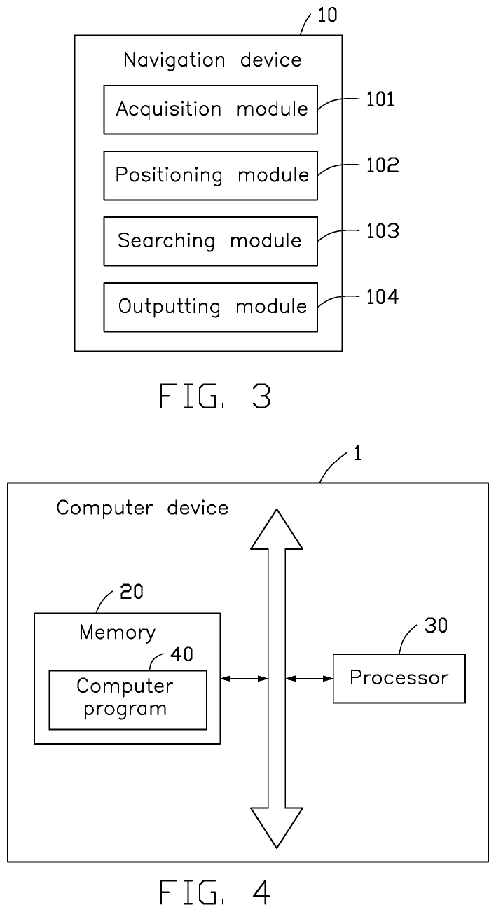

The function modules of the software device which apply the navigation method and the hardware device architecture of the navigation method are introduced in combination with FIG. 3 and FIG. 4. It should be understood that the embodiments are for illustrative purposes only and are not subject to a particular illustration of structure in the scope of patent applications.

As in shown FIG. 3, in some embodiments, the navigation device 10 is operated in a computer device. The computer device telecommunication connects to a plurality of user terminals through network. The navigation device 10 may include a plurality of functional modules composed of plurality of program code segments. The program code of each program segment in the navigation device 10 may be stored in a memory of the computer device and executed by the at least one processor to realize the navigation function.

In this embodiment, the navigation device 10 may be divided into a plurality of functional modules according to functions performed by the navigation device 10. As shown in FIG. 3, the navigation device 10 may include: an acquisition module 101, a positioning module 102, a searching module 103, and an outputting module 104. The modules refer to a series of computer program segments which can be executed by at least one processor and can complete fixed functions, which are stored in a memory.

In this embodiment, the functions of each module will be detailed in subsequent embodiments.

The acquisition module 101 is configured for acquiring two-dimensional codes information by using a code scanning unit of a user terminal 2 to scan two-dimensional codes.

In one embodiment, the two-dimensional code at least can be selected from one of a two-dimensional code of a doorplate and a two-dimensional code carried by a store or store chain.

The method for acquiring the two-dimensional code information can be selected from one of the two following ways:

A first way: a doorplate code is scanned by a code scanning unit of a user terminal 2, and positional information in the two-dimensional code is extracted. Wherein the positional information comprises at least one of a residential quarter name and a doorplate number.

A second way: a two-dimensional code carried by a store or store chain is scanned by a code scanning unit of a user terminal 2, and positional information in the store code is extracted; the store positional information comprises at least one of a store name and a store address.

For example, a doorplate two-dimensional code is scanned by a code scanning unit of a user terminal 2, and the doorplate two-dimensional code information is sent to the acquisition module 101 of the computer device 1. For example, positional information corresponding to the doorplate two-dimensional code is Building Block 5, room 101, Construction Road 128. In another embodiment, a store code is scanned by a two-dimensional scanned unit of a tablet computer. The store code includes store name and store address. The store name and store address is sent to the acquisition module 101 of the computer device 1 via network. For example, the store code information is a certain supermarket of Construction Road.

In the embodiment, the navigation device further comprises an information processing module for extracting positional information of each piece of two-dimensional code information.

The positioning module 102 is configured for comparing the acquired two-dimensional code information with the information in a database, and positioning the positional information of the two-dimensional code information in a map. Wherein a map of the preset area and a corresponding relation of all the positional information in the map and the two-dimensional code information are stored in the database.

In one embodiment, a process of building the database may include:

Firstly, a plurality pieces of two-dimensional code information of a preset area are acquired.

Secondly, positional information of each two-dimensional code information is extracted.

Thirdly, each positional information is marked on a map of the preset area, and the map of the preset area comprises the positional information of all the buildings in the preset area. The preset area can be an interior of a public place such as a large shopping mall, an exhibition hall, and the like, and can also be a city, a country, and the like.

For example, the positioning module 102 acquires all two-dimensional code information in a preset area transmitted by the code scanning unit of a user terminal 2. Wherein the positional information in each two-dimensional code information may comprise a road name, a building name, a doorplate number, shop name, a community name, and the like. The positioning module 102 is used for marking the positional information on a map of a preset area, and the map of the preset area comprises the positional information of all buildings in the preset area.

The steps of comparing the obtained two-dimensional code information with the information in the database, and locating the positional information of the two-dimensional code information may include:

Firstly, a positional information corresponding to each two-dimensional code information is obtained.

Secondly, each positional information is looked up in the database and each positional information is marked on the map of the preset area.

For example, the positioning module 102 acquires the two-dimensional code information transmitted by the code scanning unit of a user terminal 2; extracts the positional information in the two-dimensional code information, and compares the positional information with the positional information in the database, then finds out the positional information in the database corresponding to the positional information, and finds the coordinate position on the map of the preset area corresponding to the positional information in the database, and lastly, stores the coordinate position and positional information of the two-dimensional code information corresponding to the coordinate position. For example, the positioning module 102 receives a two-dimensional code sent by the code scanning unit of a user terminal 2 and extracts a positional information of the two-dimensional code as being Room 101, Building 5 at 128 Construction Road, and the positioning module 102 compares the positional information with the positional information in the database, and finds out that the coordinate information corresponding to the positional information is: longitude, 96° 10.9′ and latitude 38° 12′, and the coordinate position and the positional information of the two-dimensional code corresponding to the coordinate position is stored in the computer device 1, and the coordinate position is marked on the map. The marking method can use special symbols, such as triangles, circles, etc., to mark on the map.

The searching module 103 is configured for receiving a target position input by a user, and finding a path information between the current position corresponding to the two-dimensional code information and a target position.

The step of finding a shortest path between the current position and the target position may include:

Firstly, obtaining the target positional information and finding the coordinates corresponding to the target positional information on a map.

Secondly, using the shortest path algorithm to determine a shortest path from the current position corresponding to the two-dimensional code information to the target position.

The step of using the shortest path algorithm to determine a shortest path from the current position corresponding to the two-dimensional code information to the target position includes:

Firstly, position coordinates of all intersections between the current position corresponding to the two-dimensional code information and the target position are marked on a map.

Secondly, a passing direction of the vehicles between each two adjacent intersections is determined.

Thirdly, a passing distance and/or passing time between each two adjacent intersections is calculated.

The shortest path algorithm is used to calculate the shortest path and the minimum use time between the current position corresponding to the two-dimensional code information and the target position according to the passing distance and/or passing time of all intersections.

For example, the searching module 103 acquires the target positional information, looks up a position coordinate corresponding to the target positional information in the map, for example, the target position is a library, the position coordinate of the library is longitude: 96° 11′, latitude: 38° 12′, and the current positional information acquired by the code scanning unit of a user terminal 2 is: longitude, 96° 10.9′ and latitude 38° 12′. Next, find position coordinates of all intersections between the target position and the position of the two-dimensional code information, and determine a travelling direction of vehicles between each two adjacent intersections, such as one-way or two-way. The travelling distance and/or time between two adjacent intersections are calculated, and the shortest path between the position corresponding to the two-dimensional code information and the target position is calculated by using the shortest path algorithm. The shortest path algorithm can include Dijkstra algorithm, A-star algorithm, highway hierarchies algorithm, and so on.

The outputting module 104 is configured for outputting the current positional information and a shortest path information between the current position to the target position.

In one embodiment, the outputting module 104 sends the current positional information corresponding to the two-dimensional code information and the current positioning information on the map to the user terminal 2 by means of SMS, mail, telephone and instant communication software.

In another embodiment, the outputting module 104 sends the current positional information corresponding to the two-dimensional code information and the path information between the current positional information to the target position to the user terminal 2 by means of SMS, mail, telephone, and instant communication software.

FIG. 4 is a schematic diagram of a computer device in accordance with one embodiment. The computer device 1 includes a memory 20, a processor 30, and a computer program 40 stored in the memory 20 and capable of running on the processor 30, such as a navigation program. The processor 30 implements the steps in the above navigation method embodiment when executing the computer program 40, such as steps S1˜S4 shown in FIG. 2. Alternatively, the processor 30 implements the functions of each module/unit in the navigation device embodiment, such as units 101-104 in FIG. 3, when executing the computer program 40.

Exemplarily, the computer program 40 may be divided into one or more modules/units stored in the memory 20 and executed by the processor 30. The one or more modules/units may be a series of computer program instruction segments capable of performing specific functions for describing the execution process of the computer program 40 in the computer device 1. For example, the computer program 40 may be divided into an acquisition module 101, a positioning module 102, a searching module 103, and an outputting module 104 as shown in FIG. 3. The function of each module is shown in FIG. 3.

The computer device 1 may be a desktop computer, a notebook, a palmtop computer, or a cloud server, etc. It will be understandable to those skilled in the art that the schematic diagram is only an example of a computer device 1 and does not constitute a limitation on the computer device 1, other examples may include more or fewer components than the diagram, or a combination of certain components, or have different components, the computer device 1 may also include an input and output device, a network access device, a bus, etc.

The processor 30 may be a central processing unit (CPU), or other general purpose processors, digital signal processors (DSP), application special purpose integrated circuits (ASIC), ready-made programmable gate arrays (FPGA) or other programmable logic devices, split gates or transistor logic devices, discrete hardware components, etc. The general purpose processor may be a microprocessor or the processor 30 may be any conventional processor, the processor 30 is the control center of the computer device 1, and each part of the whole computer device 1 is connected by various interfaces and circuits.

The memory 20 may be used to store the computer program 40 and/or module/unit, and the processor 30 realizes various functions of the computer device 1 by running or executing a computer program and/or module/unit stored in the memory 20, and by calling the data stored in the memory 20. The memory 20 may mainly include a storage program area and a storage data area, wherein the storage program area can store the operating system, at least one application program required by the function (such as sound playback function, image playing function, etc.), etc.; the storage data area may store the data created according to the use of the computer device 1 (such as audio data, telephone book, etc.), etc. In addition, memory 20 may include high-speed random access memory, as well as non-volatile memory, such as hard disk, memory, plug-in hard disk, intelligent memory card (Smart Media Card, SMC), secure digital (Secure Digital, SD) card, flash card (Flash Card), at least one disk memory device, flash memory device, or other volatile solid-state storage device.

If the module/unit integrated by the computer device 1 is implemented in the form of a software functional unit and sold or used as an independent product, it can be stored in a computer readable storage medium. Based on this understanding, the subject matter realizes all or part of the flow in the embodiment of method, and can also be completed by instructing the relevant hardware by a computer program. The computer program can be stored in a computer readable storage medium, and the computer program can realize the steps of each method embodiment when the computer program is executed by the processor. The computer program includes computer program code, which can be in the form of source code, object code, executable file or some intermediate form, etc. The computer readable medium may include any entity or device capable of carrying the computer program code, a recording medium, a U disk, a mobile hard disk, a disk, an optical disc, a computer memory, a read-only memory (ROM), random access memory (RAM), carrier signal, telecommunications signal, software distribution medium, etc.).

It should be noted that the content contained in the computer-readable medium may be appropriately increased or subtracted in accordance with the requirements of legislation and patent practice in a jurisdiction, for example, in some jurisdiction, according to legislation and patent practice, a computer-readable medium does not include electric carrier signals and telecommunications signals. In several embodiments provided by the subject matter, it should be understood that the disclosed computer device and method can be realized in other ways. For example, the computer device embodiment described above is only indicative, for example, the division of the unit is only a logical function division, and there can be another division mode when it is actually implemented. In addition, each functional unit in each embodiment of the subject matter can be integrated in the same processing unit, or each unit can exist physically separately, or two or more units can be integrated in the same unit. The integrated unit can be realized not only in the form of hardware, but also in the form of hardware and software function module.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A navigation method, comprising:
scanning a two-dimensional code using a code scanning unit of a user terminal and obtaining a piece of two-dimensional code information;
comparing the acquired two-dimensional code information with information stored in a database, and positioning a current positional information determined by the two-dimensional code information in a map, wherein the database stores the map of a preset area and a corresponding relation between each positional information in the map and a corresponding two-dimensional code information of the preset area;
receiving a target position input by a user, and finding a path information between the current positional information corresponding to the two-dimensional code information and the target position; and
outputting the current positional information and the path information to the user terminal.

2. The method of claim 1, wherein:
the two-dimensional code is a doorplate two-dimensional code or a store two-dimensional code.

3. The method of claim 2, wherein:
the method for acquiring the two-dimensional code information at least can be selected from one of two methods as follows:
a doorplate two-dimensional code is scanned by a code scanning unit of a user terminal, and positional information in the two-dimensional code information is extracted, wherein the positional information comprises at least one of a residential quarter name and a doorplate number; or
a store code is scanned by a code scanning unit of a user terminal, and store positional information in the store code is extracted; and the store positional information comprises at least one of a store name and a store address.

4. The method of claim 3, wherein:
a method for building the database comprises steps:
acquiring a plurality pieces of two-dimensional code information of the preset area;
extracting positional information of each piece of two-dimensional code information; and
marking each piece of positional information on the map of the preset area, and the map of the preset area comprises positional information of all buildings in the preset area.

5. The method of claim 1, wherein:
the method of comparing the obtained two-dimensional code information with the information in the database, and locating the positional information of the two-dimensional code information comprises:
obtaining a positional information of each piece of two-dimensional code information; and
looking up each positional information in the database and locating each positional information on the map of the preset area.

6. The method of claim 5, wherein
the method of finding the path information between the current positional information and the target position comprises:
obtaining the target positional information and finding coordinates corresponding to the target positional information on the map; and
determining every path from the current positional information of the two-dimensional code information to the target position using a shortest path algorithm.

7. The method of claim 6, wherein:
the method of determining all paths from the current position corresponding to the two-dimensional code information to the target position by using the shortest path algorithm comprises:
marking the position coordinates of all intersections between the position determined by the two-dimensional code information and the target position on the map;
determining a passing direction of vehicles between each two adjacent intersections; calculating a passing distance and/or a passing time period between each two adjacent intersections; and
determining a shortest path and a least time between the position determined by the two-dimensional code information and the target target position using a shortest path algorithm.

8. A navigation device, comprising:
an acquisition module configuring for acquiring a piece of two-dimensional code information by using a code scanning unit to scan a two-dimensional codes;
a positioning module configuring for comparing the acquired two-dimensional code information with the information stored in a database, and positioning a current positional information determined by the two-dimensional code information in a map, wherein the database stores the map of a preset area and a corresponding relation between each positional information of the map and a corresponding two-dimensional code information of a building;
a searching module configuring for receiving a target position input by a user, and finding a path information between the current position determined by the two-dimensional code information and a target position; and
an outputting module configuring for outputting the current positional information and a shortest path information between the current position to the target position to the user terminal.

9. The navigation device of claim 8, wherein:
the two-dimensional code is a doorplate two-dimensional code or a store two-dimensional code.

10. The navigation device of claim 9, wherein:
the positional information comprises at least one of a residential quarter name and a doorplate number or at least one of a store name and a store address.

11. The navigation device of claim 10, wherein:
the acquisition module further configures for acquiring a plurality pieces of two-dimensional code information of the preset area; and
further comprises an information processing module for extracting positional information of each piece of two-dimensional code information and marking each piece of positional information on the map of the preset area.

12. A computer device, comprising:
a memory for storing a computer program;
and a processor telecommunications with the memory, wherein the processor is able to execute the computer program, and the computer program is configured to carry out a navigation method, and wherein the navigation method comprising:
scanning a two-dimensional code using a code scanning unit of a user terminal and obtaining a piece of two-dimensional code information;
comparing the acquired two-dimensional code information with information stored in a database, and positioning a current positional information determined by the two-dimensional code information in a map, wherein the database stores the map of a preset area and a corresponding relation between each positional information in the map and a corresponding two-dimensional code information of the preset area;
receiving a target position input by a user, and finding a path information between the current positional information corresponding to the two-dimensional code information and the target position; and
outputting the current positional information and the path information to the user terminal.
